(19) United States
(12) Patent Application Publication
(10) Pub. No.: US 2011/0089163 A1
(43) Pub. Date: Apr. 21, 2011

(54) ACTIVATED-STEAM-GENERATING APPARATUS

(75) Inventors: Naoto Fujimura, Yokohama-shi (JP); Hideyuki Yamato, Kokubunji-shi (JP)

(73) Assignee: NEW NATURE CO., LTD., Joyo-shi, Kyoto (JP)

(21) Appl. No.: 12/995,622

(22) PCT Filed: May 29, 2009
(86) PCT No.: PCT/JP2009/059892

§ 371 Date: Dec. 1, 2010

(30) Foreign Application Priority Data
Jun. 2, 2008 (JP) 2008-144513

(51) Int. Cl. H05B 6/10

(52) U.S. Cl. 219/628

(57) ABSTRACT

An apparatus comprising (a) a steam-induction-heating apparatus, which comprises a first container having an inlet and an outlet, a high-frequency induction coil wound around said first container, and a member or members placed in said first container with steam permitted to pass therethrough for being induction-heated by said high-frequency induction coil; and (b) an electric discharge treatment apparatus located downstream of said induction-heating apparatus, which comprises a second container having an inlet and an outlet, and at least a pair of electrodes disposed in said second container for subjecting induction-heated steam to an electric discharge treatment; superheated steam exiting from the outlet of said induction-heating apparatus being converted to the activated steam by an electric discharge treatment in said electric discharge treatment apparatus.

### FIELD OF THE INVENTION

The present invention relates to an apparatus for efficiently generating activated steam with relatively lower power consumption.

### BACKGROUND OF THE INVENTION

Superheated steam at higher than 100° C. having a higher thermal conductivity than that of heated air is widely used for processing foods and disposals, carbonization, surface treatments, etc. Various apparatuses generating superheated steam have been proposed. For example, JP 2003-297537 A discloses a superheated-steam-generating apparatus comprising an electrically non-conductive, pipe-shaped water container, a high-frequency induction coil wound around said electrically non-conductive, pipe-shaped container, and pluralities of conductive pipes placed in said electrically non-conductive, pipe-shaped container for being induction-heated by the high-frequency induction coil. This apparatus can generate superheated steam with low power consumption.

JP 2004-251605 A discloses an apparatus comprising a pipe-shaped container, a high-frequency induction coil wound around said container, and a large number of spherical bodies placed in the pipe-shaped container, steam generated by a boiler being introduced into the pipe-shaped container, in which it is converted to superheated steam by induction heating with the high-frequency induction coil. This apparatus can generate superheated steam at 450° C. or higher.

However, superheated steam obtained by the above apparatuses is not active enough at relatively low temperatures. Steam can be activated by an electric discharge treatment. JP 2002-159935 A proposes an apparatus for generating steam plasma (activated steam) as high as 10,000° C. from steam by arc discharge. However, the generation of steam plasma at such high temperatures needs large power consumption.

### OBJECT OF THE INVENTION

Accordingly, an object of the present invention is to provide an apparatus generating highly activated steam with relatively low power consumption.

### DISCLOSURE OF THE INVENTION

As a result of intensive research in view of the above object, the inventors have found that highly activated steam can be obtained with relatively low power consumption by subjecting superheated steam generated by induction heating to an electric discharge treatment. The present invention has been completed based on such finding.

The first activated-steam-generating apparatus of the present invention comprises (a) a steam-induction-heating apparatus, which comprises a first container having an inlet and an outlet, a high-frequency induction coil wound around said first container, and a member or members placed in said first container with steam permitted to pass therethrough for being induction-heated by said high-frequency induction coil; and (b) an electric discharge treatment apparatus located downstream of said induction-heating apparatus, which comprises a second container having an inlet and an outlet, and at least a pair of electrodes disposed in said second container for subjecting induction-heated steam to an electric discharge treatment; superheated steam exiting from the outlet of said induction-heating apparatus being converted to the activated steam by an electric discharge treatment in said electric discharge treatment apparatus.

In an embodiment of the present invention, the first and second containers are made of a metal, and said induction-heating apparatus and said electric discharge treatment apparatus are connected via an electrically insulating pipe, through which one electrode of said electric discharge treatment apparatus passes. In another embodiment of the present invention, both of the first and second containers are made of electrically insulating ceramics.

The second activated-steam-generating apparatus of the present invention comprises an electrically insulated container having an inlet and an outlet, and containing a steam-induction-heating zone on the upstream side and an electric discharge treatment zone on the downstream side; a high-frequency induction coil wound around said induction-heating zone; a member or members placed in said induction-heating zone such that steam can flow therethrough, and induction-heated by said high-frequency induction coil; and at least a pair of electrodes disposed in said electric discharge treatment zone; steam introduced into said electrically insulated container through said inlet being converted to superheated steam by induction heating in said induction-heating zone, and then to the activated steam by an electric discharge treatment in said electric discharge treatment zone.

In both of the first and second activated-steam-generating apparatuses, the member or members to be induction-heated is or are preferably porous member or members, more preferably porous metal member or members, most preferably made of electrically conductive, soft-magnetic metal materials. Said member or members to be induction-heated preferably has or have a vacancy ratio of 30-80% by volume. Said member or members to be induction-heated preferably has or have a vacancy ratio higher on the outlet side than on the inlet side in said container. Said first container preferably contains pluralities of porous members having a vacancy ratio increasing successively from the inlet side. The temperature of said superheated steam is preferably in a range of 120° C. to 350° C.

### BRIEF DESCRIPTION OF THE DRAWINGS

FIG. 1 is a longitudinal, cross-sectional view showing one example of the first activated-steam-generating apparatuses of the present invention.

FIG. 1(b) is an exploded cross-sectional view showing an important portion of the first activated-steam-generating apparatus of the present invention.

FIG. 1(c) is a view schematically showing the change of the number of water molecules in the induction-heating apparatus.

FIG. 2 is a longitudinal, cross-sectional view showing another example of induction-heating apparatuses used in the first activated-steam-generating apparatus of the present invention.

FIG. 3(a) is a longitudinal, cross-sectional view showing another example of induction-heating apparatuses used in the first activated-steam-generating apparatus of the present invention.

FIG. 3(b) is a plan view showing the arrangement of electrode wires in the electric discharge treatment apparatus shown in FIG. 3(a).

FIG. 3(c) is a cross-sectional view taken along the line A-A in FIG. 3(b).

FIG. 4 is a longitudinal, cross-sectional view showing a further example of induction-heating apparatuses used in the first activated-steam-generating apparatus of the present invention.

FIG. 5(a) is a longitudinal, cross-sectional view showing a still further example of induction-heating apparatuses used in the first activated-steam-generating apparatus of the present invention.

FIG. 5(b) is a cross-sectional view taken along the line B-B in FIG. 5(a).

FIG. 6(a) is a longitudinal, cross-sectional view showing a still further example of induction-heating apparatuses used in the first activated-steam-generating apparatus of the present invention.

FIG. 6(b) is a cross-sectional view taken along the line C-C in FIG. 6(a).

FIG. 7(a) is a longitudinal, cross-sectional view showing a still further example of induction-heating apparatuses used in the first activated-steam-generating apparatus of the present invention.

FIG. 7(b) is a cross-sectional view taken along the line D-D in FIG. 7(a).

FIG. 7(c) is a partial, enlarged, perspective view showing the arrangement of electrode wires in the electric discharge treatment apparatus.

FIG. 7(d) is a partial, enlarged, perspective view showing the arrangement of electrode wires in the electric discharge treatment apparatus.

FIG. 8 is a partial, cross-sectional view showing another example of the first activated-steam-generating apparatuses of the present invention.

FIG. 9 is a partial, cross-sectional view showing a further example of the first activated-steam-generating apparatuses of the present invention.

FIG. 10 is a longitudinal, cross-sectional view showing an example of the second activated-steam-generating apparatus of the present invention.

FIG. 11(a) is a plan view schematically showing the erasure of prints with the activated-steam-generating apparatus of the present invention.

FIG. 11(b) is a side view schematically showing the erasure of prints with the activated-steam-generating apparatus of the present invention.

FIG. 12 is a cross-sectional view schematically showing the production of carbon from biomass with the activated-steam-generating apparatus of the present invention.

### DESCRIPTION OF THE BEST MODE OF THE INVENTION

The embodiments of the present invention will be explained in detail referring to the attached drawings, and explanations made in each embodiment are applicable to the other embodiments unless otherwise mentioned.

[1] First Activated-Steam-Generating Apparatus

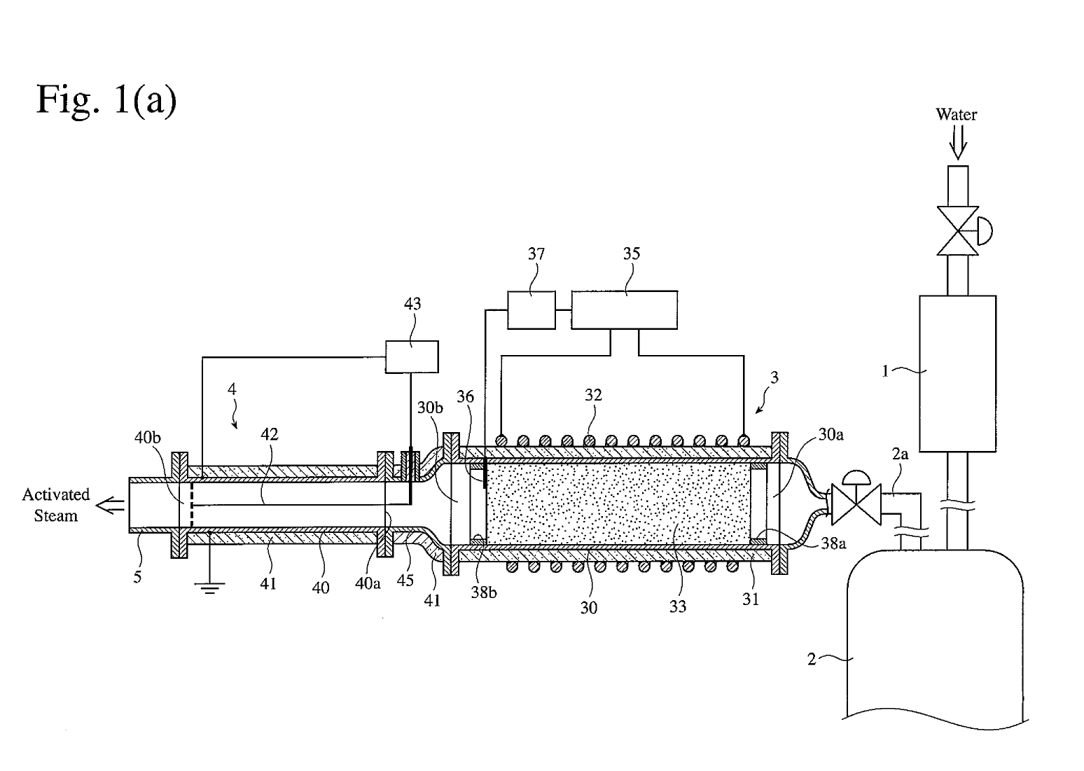

As shown in FIGS. 1(a) and 1(b), a boiler 2 for generating steam from pure water supplied from a water-purifying means 1 connected to a water tap is connected via a pipe 2a to the first activated-steam-generating apparatus comprising an apparatus 3 for induction-heating steam to generate superheated steam, and an apparatus 4 for discharge-treating the superheated steam to generate activated steam.

(1) Induction-Heating Apparatus

The induction-heating apparatus 3 comprises a pipe-shaped container 30 having an inlet 30a and an outlet 30b, a high-frequency induction coil 32 formed by a copper pipe or wire and wound around the pipe-shaped container 30 via an electric insulator 31, a high-frequency power supply 35 supplying high-frequency current to the high-frequency induction coil 32, members 33 placed in the container 30 with steam permitted to pass therethrough and induction-heated by high-frequency current, a temperature sensor 36 disposed near the outlet 30b of the container 30 for detecting the temperature of the superheated steam obtained by induction heating, and a controller 37 for controlling the high-frequency power supply 35 according to the detection data of the temperature sensor 36.

(a) Container

The container 30 is preferably made of materials not substantially induction-heated by high-frequency current flowing through the high-frequency induction coil 32, and resistant to deterioration by the resultant superheated steam. Such materials include non-magnetic metals such as non-magnetic stainless steel (SUS304 etc.), aluminum and copper, ceramics, heat-resistant glass, graphite, etc. In the case of using non-magnetic metals, the inner surface of the container 30 may be coated with glass to have higher corrosion resistance. For easier maintenance, the container 30 may be constituted by pluralities of detachable pipes each having a flange.

(b) Member or Members to be Induction-Heated

Because induction heating is caused by eddy current loss or magnetic hysteresis loss occurring in an electrically conductive body placed in a high-frequency magnetic field, the member or members 33 is or are preferably made of materials having excellent soft-magnetic properties and modest conductivity. Further, the member or members 33 is or are exposed to the superheated steam, it or they preferably has or have excellent corrosion resistance. Accordingly, the member or members 33 to be induction-heated is or are preferably made of corrosion-resistant, soft-magnetic metals. Such metals are preferably magnetic stainless steel (SUS430, SUS403, SUS447J1, SUSXM27, etc.). In addition, electrically conductive ceramics such as carbon ceramics made of carbon and boron-silicated glass are also usable. To have a contact area necessary for generating the superheated steam while avoiding excessive pressure loss, the vacancy ratio of the member or members 33 to be induction-heated is preferably 30-80% by volume.

A member 33 to be induction-heated in a preferred embodiment of the present invention is preferably a cylindrical, porous metal member, which substantially occupies a space inside the container 30. The porous metal member is fixed to the container 30 by a pair of supports 38a, 38b. The porous metal member can be produced by (i) a method of molding a slurry comprising metal powder, pore-forming resin powder, an organic binder and a solvent to a predetermined shape, drying the resultant molding, burning the organic binder and the resin powder, and sintering the molding; (ii) a method of impregnating foamed polyurethane with a metal powder slurry, and drying and sintering it; (iii) a method of sintering metal fibers entangled in a non-woven manner; etc.

(2) Electric Discharge Treatment Apparatus

The electric discharge treatment apparatus 4 comprises a container 40 having an inlet 40a communicating with the outlet 30b of the induction-heating apparatus 3, and an outlet 40b ejecting an activated steam jet; an insulating member 41 surrounding the container 40; an electrode wire 42 extending along a center axis of the container 40; and a power supply 43 connected to the electrode wire 42. The container 40 made of an electrically conductive metal may be used as a counter electrode to the electrode wire 42. The electrically conductive metals include copper, aluminum, stainless steel, etc. Because the activated steam is generated in the container 40, the inner surface of the container 40 and the electrode wire 42 are preferably coated with glass. The power supply 43 generates a pulse or sinusoidal wave.

The volume ratio of the container 30 of the induction-heating apparatus 3 to the container 40 of the electric discharge treatment apparatus 4 may be properly determined, but it is preferably 10/1 to 1/10.

When the container 30 of the induction-heating apparatus 3 is made of a metal, an insulating pipe 45, through which an electrode wire 42 passes, is preferably disposed between the inlet 40a of the electric discharge treatment apparatus 4 and the outlet 30b of the induction-heating apparatus 3, to achieve sufficient insulation between the electrode wire 42 and the metal container 30 acting as a counter electrode. Materials forming the insulating pipe 45 are Teflon (trademark), heat-resistant glass, ceramics, etc. A tube 5 having an opening shaped to eject an activated steam jet is preferably attached to the outlet 40b of the electric discharge treatment apparatus 4.

(3) Generation of Activated Steam

Saturated steam at 100° C. or higher, for example, at 110 to 140° C., is generated by the boiler 2. The pressure of this saturated steam is about 1.2-2 atms. To prevent oxidation, the saturated steam is preferably substantially free of oxygen. The amount (L/sec) of saturated steam supplied to the induction-heating apparatus 3 is preferably 5 times or more the vacant volume (L) of the member or members 33 to be induction-heated. The flow rate of the induction-heated steam is much higher than expected from the temperature elevation of the steam. This seems to be due to the fact that clusters of plural water molecules are disassembled in the induction-heated steam, resulting in extreme increase in the number of water molecules as schematically shown in FIG. 1(c). While steam flows through the induction-heated member or members 33 having a vacancy ratio of 30-80% by volume, pressure increase due to increase in the number of water molecules is predominantly conveyed downstream than upstream, the flow rate of the stream is much higher at the outlet 30b than the inlet 30a. The details of clusters of water molecules are described in the online article of “New science of liquid starting from molecular clusters,” Akihiro Wakisaka, January 2000, NIRE news of the Technology Research Center For Resources And Environment, which was downloaded from URL:http://www.aist.go.jp/NIRE/publica/news-2000/2000-01-3.htm on Jan. 8, 2008.

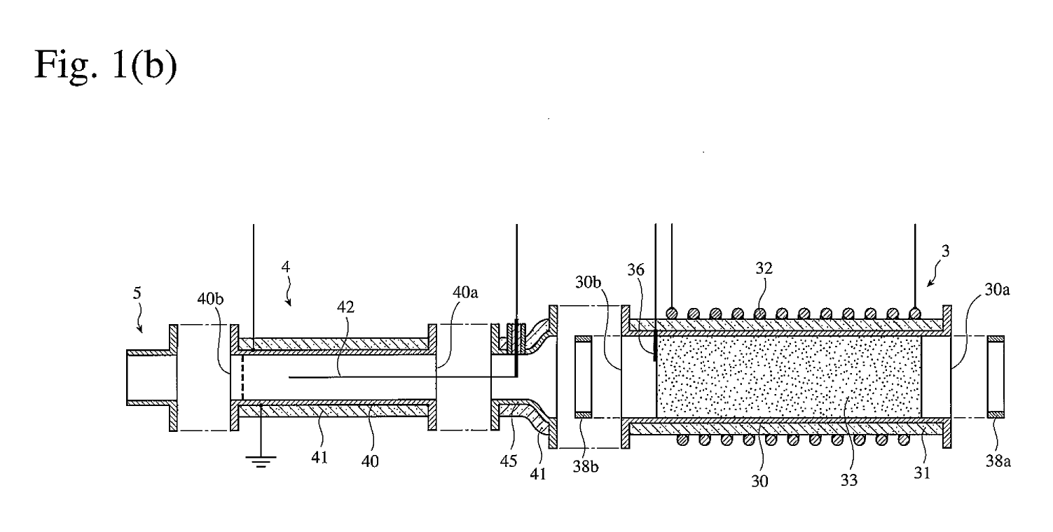

As shown in FIG. 2, when members 33 to be induction-heated are constituted by pluralities of (3 in the depicted example) porous members 33a to 33c arranged such that their vacancy ratios successively increase from the inlet 30a in a range of 30-80% by volume, the superheated steam in which the number of molecules has increased due to the disassembly of clusters can be efficiently ejected from the outlet 30b.

To generate the superheated steam substantially free of oxygen, the temperature of the superheated steam is preferably 120-350° C., more preferably 150-250° C., most preferably 150-200° C. The term “substantially free of oxygen” used herein means that the total concentration of oxygen molecules, oxygen ions, oxygen radicals and ozone is 0.5% by mol or less, based on the total amount (100% by mol) of all water molecules, ions and radicals.

The superheated steam introduced into the electric discharge treatment apparatus 4 is converted to activated steam in the form of low-temperature plasma by an electric discharge treatment. When the superheated steam substantially free of oxygen is subject to an electric discharge treatment (plasma treatment) at relatively low temperatures, it is presumed that hydroxyl radicals are generated by the reaction of H₂O→OH.+H., without generating oxygen radicals. The present invention generates hydroxyl radicals efficiently, presumably because the clusters of water molecules are disassembled before the electric discharge treatment.

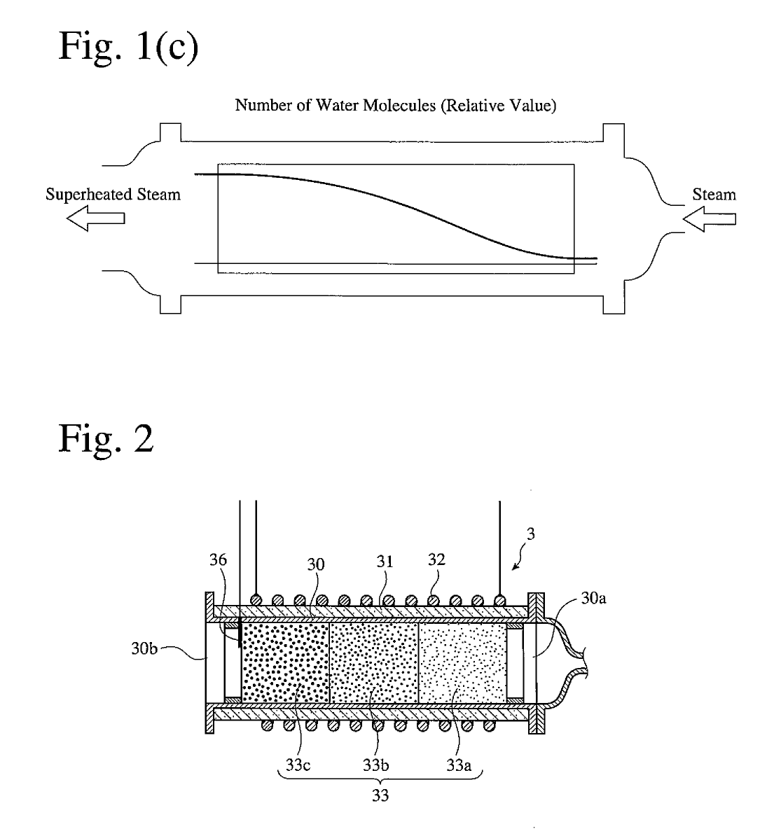

FIGS. 3(a) to 3(c) show an electric discharge treatment apparatus 4 comprising a flat-shaped container 40 having substantially the same transverse cross section as that of the container 30 of the induction-heating apparatus 3. Plural (5 in this example) electric wires 42 are arranged with equal intervals in the container 40. A metal container 40 may act as a counter electrode. Higher discharging efficiency is obtained by a structure in which plural electrode wires 42a are arranged with narrow gaps against the counter electrode.

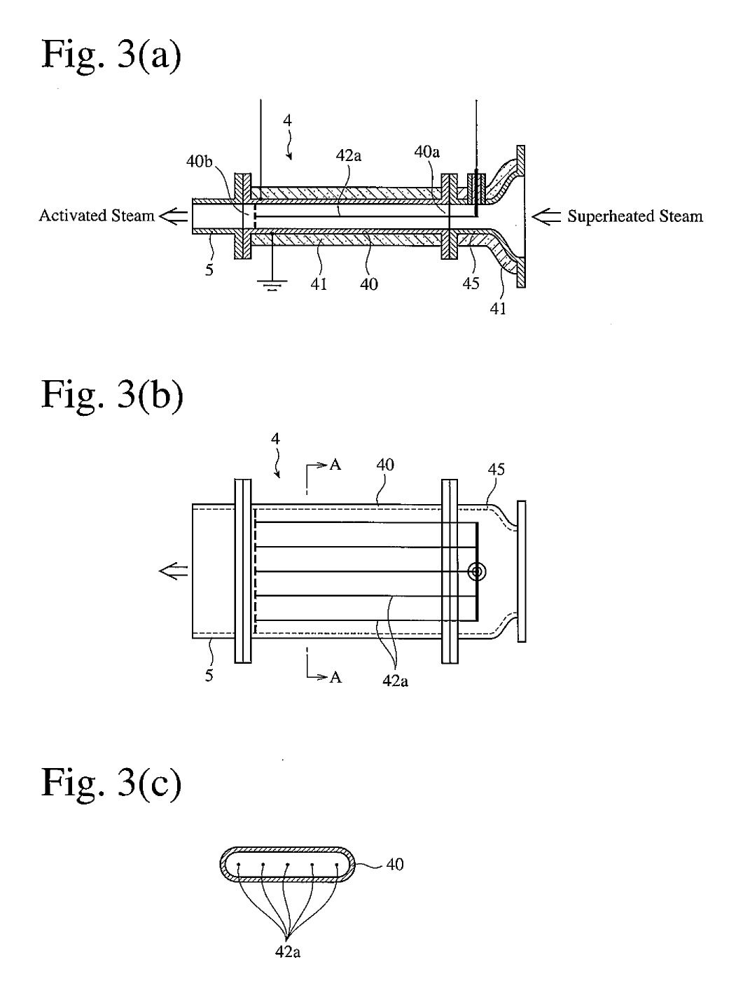

In the example shown in FIG. 4, the container 30 of the induction-heating apparatus 3 comprising pluralities of partitions 33d having through-holes is packed with a large number of spherical or tubular members 33e to be induction-heated. The partitions 33d are fixed by a center rod 34. The partitions 33d and the members 33e to be induction-heated are preferably made of the same magnetic metal as described above. In the case of spherical members 33e to be induction-heated, they are provided with holes and/or recesses to increase their contact areas with steam. The members 33e to be induction-heated preferably occupy the space of the container 30 at a vacancy ratio (vacancy ratio inside the members to be induction-heated+vacancy ratio between the members to be induction-heated) of 30-80% by volume, and the vacancy ratio preferably increases from the inlet 30a to the outlet 30b of the container 30.

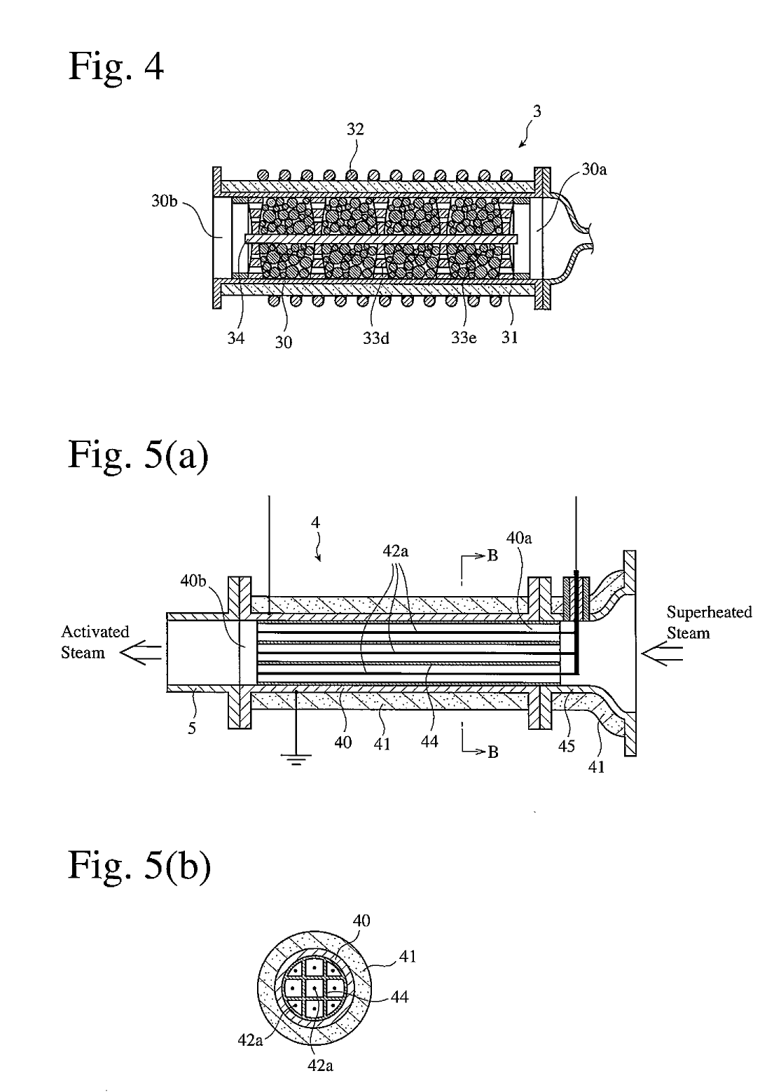

FIGS. 5(a) and 5(b) show an electric discharge treatment apparatus 4 comprising a dielectric honeycomb 44 extending in the container 40 substantially over its entire length, an electrode wire 42a being received in each cell of the honeycomb 44. The other structures may be the same as those shown in FIG. 1. The dielectric honeycomb 44 is preferably made of dielectric materials such as glass, barium titanate, lead zirconate titanate, lead titanate, lead zirconate, etc. With voltage applied between the electrode wires 42a and a counter electrode (for example, the metal container 40), barrier discharge occurs.

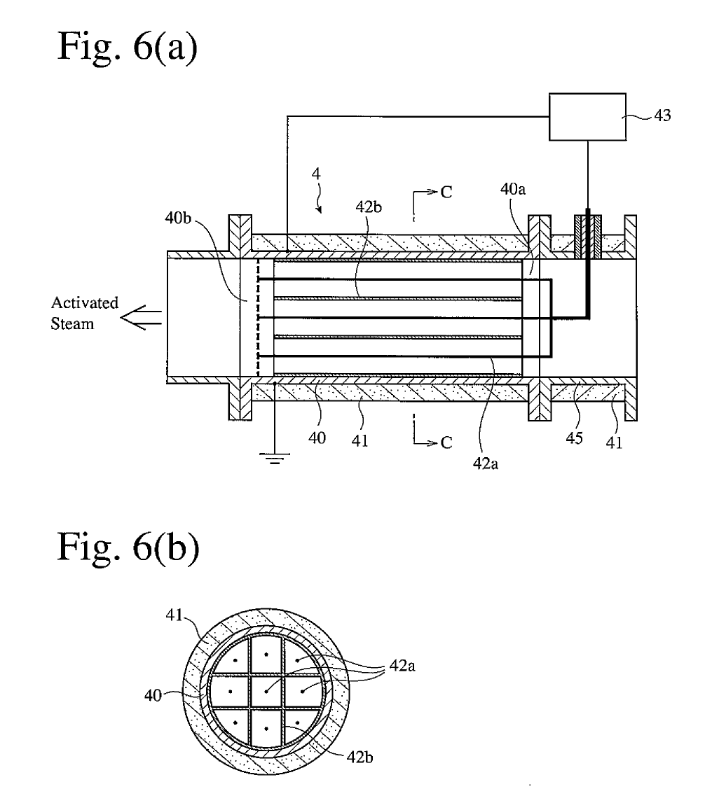

FIGS. 6(a) and 6(b) show an electric discharge treatment apparatus 4 comprising a honeycomb-shaped electrode 42b extending in the container 40 substantially over its entire length, an electrode wire 42a being received in each cell of the honeycomb. A flow path in each cell has the same cross section area. When the container 40 is made of a metal, the mere contact of the honeycomb-shaped electrode 42b with the inner surface of the container 40 turns the honeycomb-shaped electrode 42b to a counter electrode of the electrode wires 42a. The other structures than this may be the same as those shown in FIG. 1. The application of pulse voltage as short as 1 μs or less between the electrode wires 42a and the honeycomb-shaped electrode 42b causes pulse-streamer discharge.

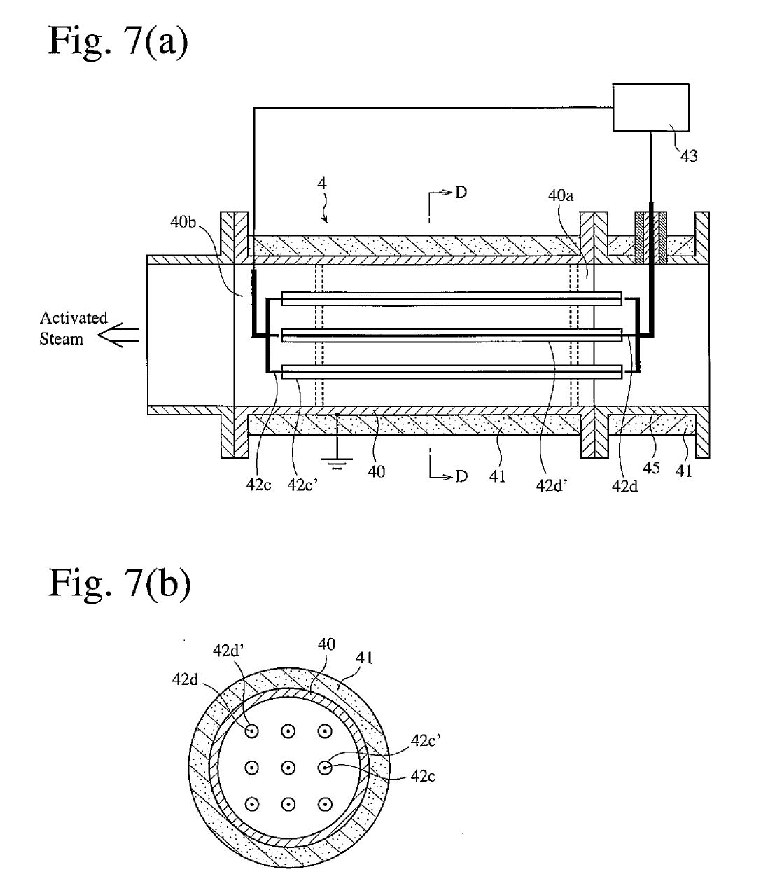

FIGS. 7(a) to 7(d) show the same electric discharge treatment apparatus 4 as shown in FIG. 1, except that pluralities of electrode wires 42c, 42d extend in the container 40 with different polarities positioned alternately. Each electrode wire 42c, 42d may be coated with an insulating material 42c′, 42d′. Instead of coating with the insulating material, each electrode wire 42c, 42d may be received in each cell of a dielectric honeycomb. The application of voltage between the electrode wires 42c, 42d with different polarities causes barrier discharge.

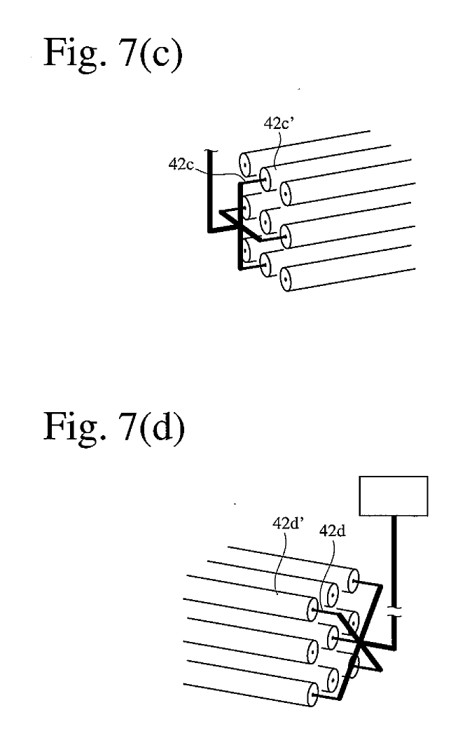

FIG. 8 shows an example, in which an insulating pipe 45, through which an electrode wire 42 penetrates, is disposed via insulating gaskets 46, 46 between the inlet 40a of the container 40 for the electric discharge treatment apparatus 4 and the outlet 30b of the container 40 for the induction-heating apparatus 3. In this example, the containers 30, 40 are made of a metal. The insulating pipe 45 is made of heat-resistant glass, ceramics, etc. Because the insulating gaskets 46, 46 should absorb thermal expansion difference between the metal containers 30, 40 and the insulating pipe 45, they should have softness and heat resistance in addition to insulation. Therefore, the insulating gaskets 46, 46 are preferably made of resins such as Teflon (trademark).

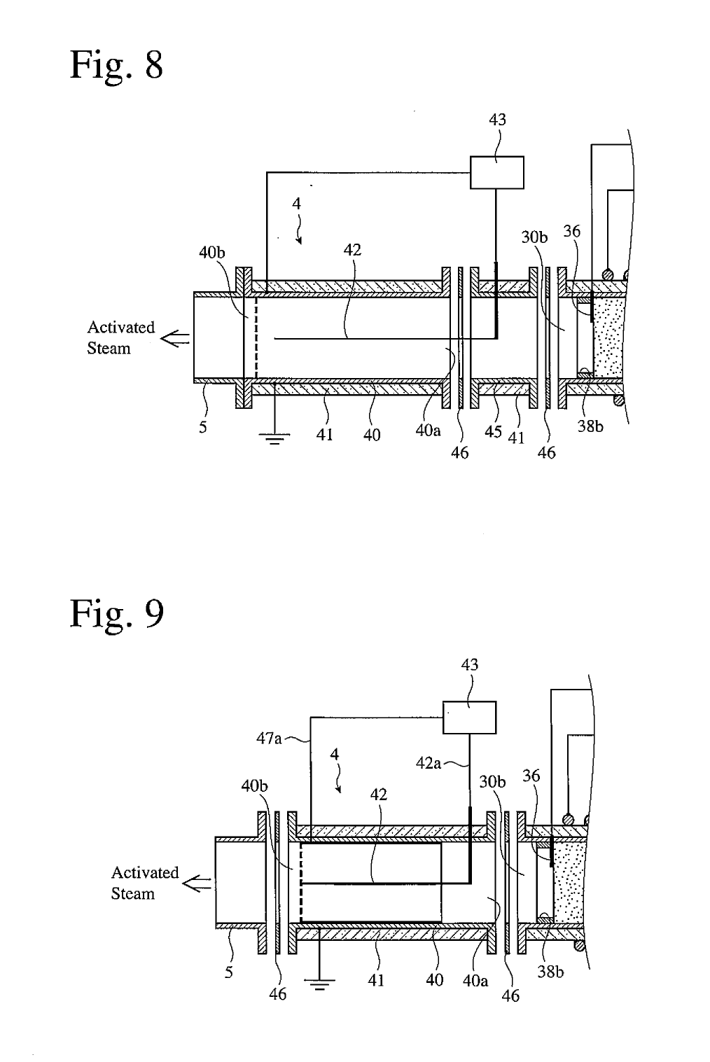

FIG. 9 shows an example, in which the container 40 of the electric discharge treatment apparatus 4 is made of insulating materials such as ceramics. In this example, an electric wire 42a for the electrode wire 42 and an electric wire 47a for a counter electrode 47 penetrate through the insulated container 40. The electrode wire 42 and the counter electrode 47 may be arranged as described above. When the container 30 of the induction-heating apparatus 3 and the activated-steam-ejecting pipe 5 are made of a metal, insulating gaskets 46, 46 are preferably disposed between the containers 40 and 30 and between the container 40 and the pipe 5, to absorb thermal expansion difference between them. Alternatively, when the container 30 is made of an insulating material, the insulating gasket 46 need only be disposed between the container 40 and the pipe 5.

(2) Second Activated-Steam-Generating Apparatus

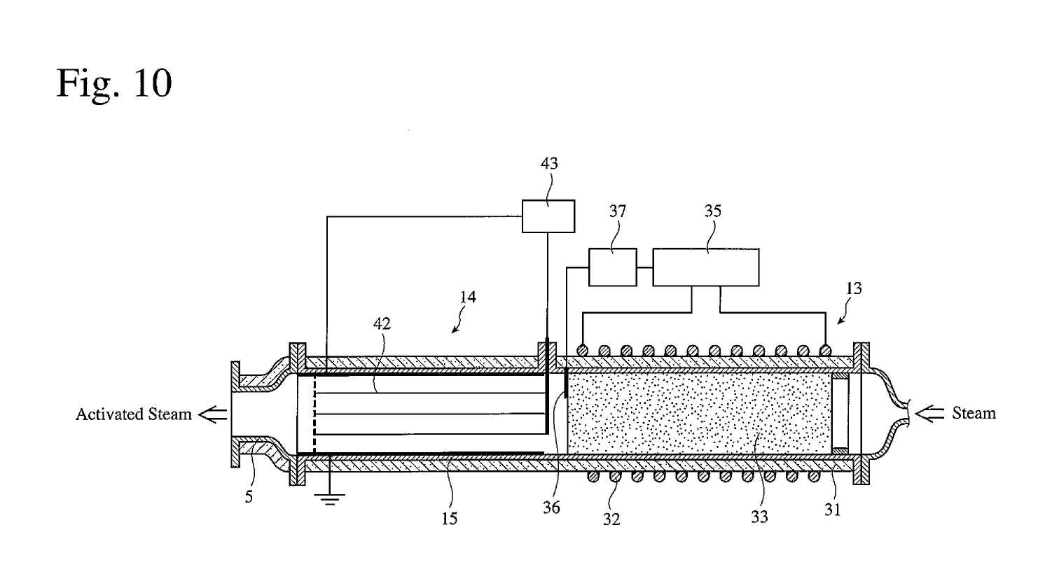

As shown in FIG. 10, the second activated-steam-generating apparatus is different from the first activated-steam-generating apparatus, in that a steam-induction-heating zone 13 and an electric discharge treatment zone 14 are placed in an insulated container 15. Steam supplied to the insulated container 15 from the boiler through a pipe is heated by a member or members (for example, porous metal member) 33 heated by high-frequency induction in the induction-heating zone 13, so that it is converted to superheated steam, and then supplied to the electric discharge treatment zone 14 downstream, in which the superheated steam is converted to activated steam by an electric discharge treatment with the electrode wires 42. Because the induction-heating zone 13 and the electric discharge treatment zone 14 are contained in one insulated container 15, activated steam can be generated efficiently with low pressure loss. The member or members 33 to be induction-heated and the electrode wires 42 may be the same as described above.

(3) Use of Activated Steam

Because the activated steam produced by the apparatuses of the present invention contains highly active hydroxyl radicals at a high concentration, it can be used for the erasure of prints such as copies, the decomposition and carbonization of biomass (plants, microorganisms, etc.), the sterilization of various items, the processing of foods (heating, drying, baking, etc.), the surface treatment of plastic films, the cleaning of semiconductors, the treatment of industrial wastes, soil improvement, etc. Particularly because the activated steam generated under an oxygen-free condition does not contain ozone, it can be used in an open system because of little influence on the environment. Because hydroxyl radicals are quickly consumed by reactions with organic materials, etc. and have extremely short lives on the micro-second order (about 20-50 μsec), the activated steam may be used in an open system without problems.

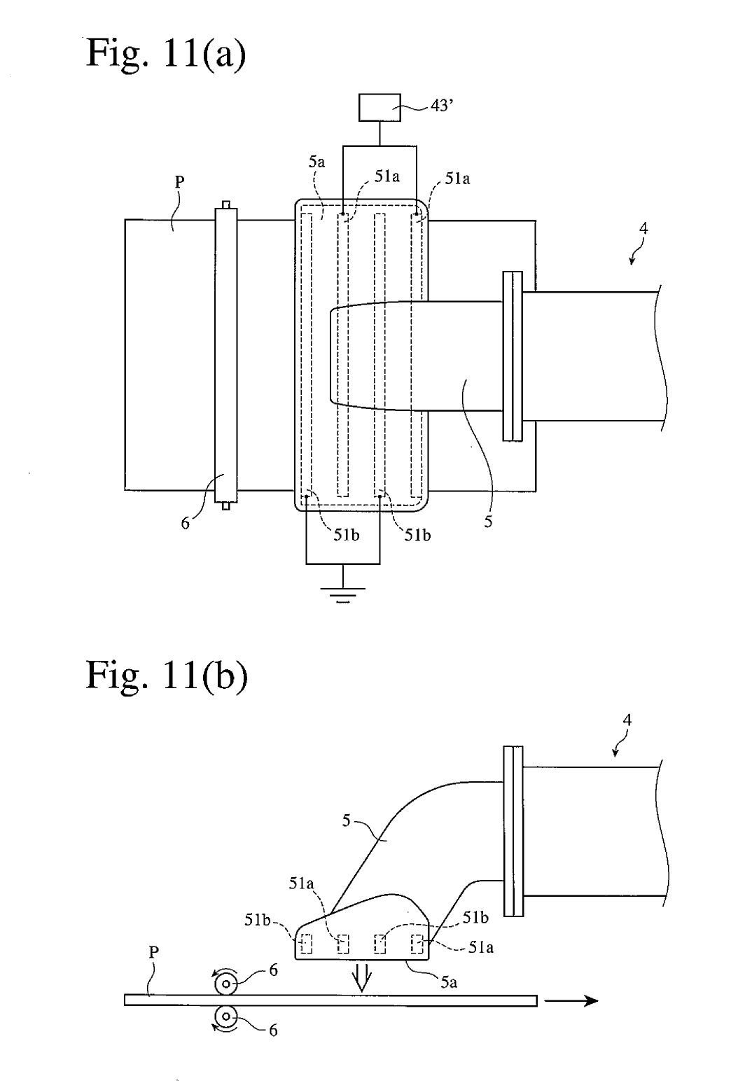

When prints are erased with the activated steam, an ejection pipe 5 having an ejection opening 5a as wide as prints is preferably attached to the outlet of the activated-steam-generating apparatus as shown in FIGS. 11(a) and 11(b). When the activated steam is ejected onto prints conveyed by a roll 6, printed characters and images are quickly erased. Because the activated steam obtained by the apparatus of the present invention has high activity (oxidizing power) even at 200° C. or lower, it can quickly erase prints at relatively low temperatures without carbonizing papers. The activated steam is especially suitable for erasing inkjet-printed characters and pictures. Opposite-polarity electrodes 51a, 52b may be alternately disposed at the ejection opening 5a of the pipe 5, at which the activated steam is subject to electric discharge.

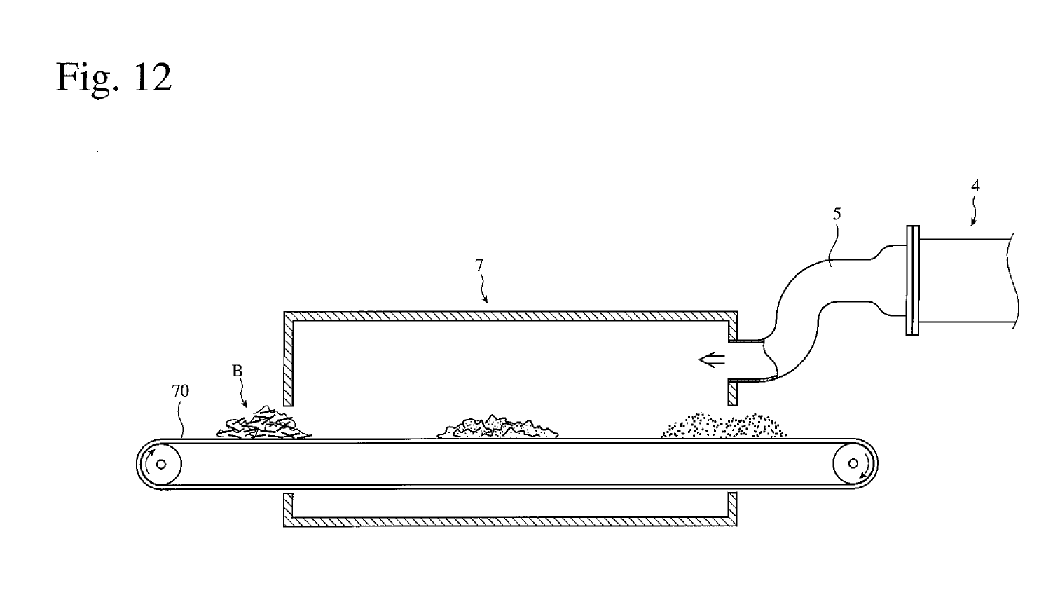

When biomass is carbonized by the activated steam, the ejection pipe 5 of the activated-steam-generating apparatus opens at a downstream end wall of a treatment chamber 7 as shown in FIG. 12. Biomass B carried by a conveyer 70 in an opposite direction to that of the activated steam is rapidly carbonized by the activated steam. Because the activated steam can carbonize biomass even at 200° C. or lower, carbon can be produced at low cost without generating toxic by-products such as benzopyrene. Substantially free from oxygen, there is little combustion loss of carbon. Particularly because carbon obtained with substantially oxygen-free, activated steam at 350° C. or lower is hydrophilic, it is suitable for inkjet ink, etc. The position of the ejection pipe 5 connected to the apparatus is not restrictive, and pluralities of activated-steam-generating apparatuses may be attached to the treating chamber 7, if necessary.

Though the present invention has been explained in detail above referring to the attached drawings and the embodiments, the present invention is not restricted thereto, but may be modified unless deviating from its scope. For example, the porous member or members may be a honeycomb, a lattice, a net, non-woven fabrics, etc. in addition to the above.

### EFFECT OF THE INVENTION

Because the superheated steam generated by induction heating is immediately subject to an electric discharge treatment in the activated-steam-generating apparatus of the present invention, highly active steam can be produced with relatively low power consumption. The activated steam generated by the apparatus of the present invention is suitable for the carbonization and decomposition of plant materials, the sterilization of various items, the erasure of prints, the surface treating of plastic films, etc.

1.-15. (canceled)

16. An activated-steam-generating apparatus comprising (a) a steam-induction-heating apparatus, which comprises a first container having an inlet and an outlet, a high-frequency induction coil wound around said first container, and a member or members permitting steam to pass therethrough and placed in said first container for being induction-heated, and (b) an electric discharge treatment apparatus, which comprises a second container located downstream of said induction-heating apparatus, and having an inlet communicating with the outlet of said induction-heating apparatus and an outlet for discharging activated steam, and at least a pair of electrodes disposed in said second container for subjecting induction-heated steam to an electric discharge treatment; superheated steam exiting from the outlet of said induction-heating apparatus being converted to the activated steam by an electric discharge treatment in said electric discharge treatment apparatus, and ejected from said outlet as a jet flow.

17. The activated-steam-generating apparatus according to claim 16, wherein said member or members to be induction-heated is or are porous member or members.

18. The activated-steam-generating apparatus according to claim 16, wherein said member or members to be induction-heated is or are made of an electrically conductive, soft-magnetic material.

19. The activated-steam-generating apparatus according to claim 16, wherein said member or members to be induction-heated has or have a vacancy ratio of 30-80% by volume.

20. The activated-steam-generating apparatus according to claim 16, wherein said member or members to be induction-heated has or have a vacancy ratio higher on the outlet side than on the inlet side in said first container.

21. The activated-steam-generating apparatus according to claim 20, wherein said first container contains pluralities of porous members having a vacancy ratio increasing successively from the inlet side.

22. The activated-steam-generating apparatus according to claim 16, wherein said first and second containers are made of a metal material, wherein said induction-heating apparatus is connected to said electric discharge treatment apparatus via an electrically insulating pipe, and wherein one of electrodes for said electric discharge treatment apparatus passes through said electrically insulating pipe.

23. The activated-steam-generating apparatus according to any claim 16, wherein said first and second containers are made of electrically insulating ceramics.

24. The activated-steam-generating apparatus according to claim 16, wherein the temperature of said superheated steam is in a range of 120° C. to 350° C.

25. An activated-steam-generating apparatus comprising an electrically insulated container having an inlet and an outlet, and containing a steam-induction-heating zone on the upstream side and an electric discharge treatment zone on the downstream side; a high-frequency induction coil wound around said induction-heating zone; a member or members placed in said induction-heating zone such that steam can flow therethrough, and induction-heated by said high-frequency induction coil; and at least a pair of electrodes disposed in said electric discharge treatment zone; steam introduced into said electrically insulated container through said inlet being converted to superheated steam by induction heating in said induction-heating zone, and then to the activated steam by an electric discharge treatment in said electric discharge treatment zone.

26. The activated-steam-generating apparatus according to claim 25, wherein said member or members to be induction-heated is or are porous member or members.

27. The activated-steam-generating apparatus according to claim 25, wherein said member or members to be induction-heated is or are made of an electrically conductive, soft-magnetic material.

28. The activated-steam-generating apparatus according to claim 25, wherein said member or members to be induction-heated has or have a vacancy ratio of 30-80% by volume.

29. The activated-steam-generating apparatus according to claim 25, wherein said member or members to be induction-heated has or have a vacancy ratio higher on the outlet side than on the inlet side.

30. The activated-steam-generating apparatus according to claim 29, wherein said induction-heating zone contains pluralities of porous members having a vacancy ratio increasing successively from the inlet side toward the outlet side in said electrically insulated container.

31. The activated-steam-generating apparatus according to claim 25, wherein the temperature of said superheated steam is in a range of 120° C. to 350° C.
